(19) United States
(12) Patent Application Publication
(10) Pub. No.: US 2006/0195580 A1
(43) Pub. Date: Aug. 31, 2006

(54) Usage request method for network system

(75) Inventors: Gun Chou, Nagano-ken (JP); Tatsuya Kiyono, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/359,600

(22) Filed: Feb. 23, 2006

(30) Foreign Application Priority Data
Feb. 25, 2005 (JP) 2005-051791

(51) Int. Cl. G06F 15/173

(52) U.S. Cl. 709/226

(57) ABSTRACT

A method of making a usage request for one or more of a plurality of request-accepting apparatuses that accept one or more usage requests in a network system including a plurality of request-making apparatuses that make one or more usage requests, and the request-accepting apparatuses, including: upon a request-making apparatus from among the request-making apparatuses receiving an instruction to use one of the request-accepting apparatuses, notifying two or more of the request-accepting apparatuses of a usage request; and upon the request-making apparatus receiving, from a request-accepting apparatus from among the request-accepting apparatuses notified of the usage request, information indicating that the request-accepting apparatus is currently available, setting the request-accepting apparatus the information was received from as an object to be used, and notifying the one or more request-accepting apparatuses notified of the usage request other than the one set as the object to be used of cancellation of the usage request.

### CROSS-REFERENCES TO RELATED APPLICATIONS

The entire disclosure of Japanese Patent Application No. 2005-051791, filed on Feb. 25, 2005, is expressly incorporated herein by reference.

### BACKGROUND

1. Technical field

The present invention relates to a method for making a request to use an apparatus that accepts usage requests (hereinafter referred to as “request-accepting apparatus[es]”) in a network system including a plurality of apparatuses that make usage requests (hereinafter, referred to as “request-making apparatus[es]”) and a plurality of request-accepting apparatuses.

2. Related Art

Network systems have conventionally been configured by connecting a plurality of devices, such as copy machines or printers, to a network and having multiple users share these devices. Recently, network-connectable scanner apparatuses (network scanners or scanner servers) have been growing in popularity, and it has also become common for multiple users to share scanner apparatuses.

As stated above, when multiple users share a plurality of devices connected to a network, user requests for using these devices can be expected to conflict, and therefore, it is necessary to properly manage usage requests. As an example of usage request management techniques, JP-A-2004-302793 discloses a scheme in which a server that collectively manages usage request information is provided, and a user, upon making an instruction for use, can access the server from his/her own terminal to obtain usage request information for each of the devices and make a usage request for a specific device (e.g., a device with few usage requests) with reference to that usage request information.

### SUMMARY

However, in the aforementioned scheme, once a user has made a request to use device A, the user will wait until device A becomes available, even if any other device emerges that can be used earlier than device A, as a result of that other device quickly dealing with its usage requests. In other words, in the above scheme, since the device to be used is determined when the usage request is made, it is impossible to conduct flexible usage request management such as determining which device to use, according to changes in the usage request status for each of the devices.

In addition, the above scheme has the problem of increased cost, because a server that manages usage request information must be separately provided. In order to avoid this cost increase, it is possible to provide any terminal with the usage request management function of that server, instead of separately providing the usage request management server. In this case, however, the processing load for that terminal will greatly increase.

Therefore, an advantage of some aspects of the invention is the provision of a scheme that, when a plurality of users (clients) share a plurality of devices connected to a network, makes it possible to conduct such flexible usage request management as determining which device to use, according to changes in the usage request status for each of the devices, without a usage request management server being separately provided.

The usage request method according to a first aspect of the invention is a method for making a usage request for one or more of a plurality of request-accepting apparatuses that accept one or more usage requests in a network system including a plurality of request-making apparatuses that make one or more usage requests, and the request-accepting apparatuses, including: upon a request-making apparatus from among the request-making apparatuses receiving an instruction to use one of the request-accepting apparatuses, notifying two or more of the request-accepting apparatuses of a usage request; and upon the request-making apparatus receiving from a request-accepting apparatus from among the request-accepting apparatuses notified of the usage request information indicating that the request-accepting apparatus is currently available, setting the request-accepting apparatus the information was received from as an object to be used, and notifying the one or more request-accepting apparatuses notified of the usage request other than the one set as the object to be used of cancellation of the usage request. The request-accepting apparatus is, for example, a network-connectable scanner apparatus.

In the above configuration, a usage request is sent to a plurality of request-accepting apparatuses when an instruction for use is made, and when one of the notified request-accepting apparatuses becomes available, that request-accepting apparatus is set as the device to be used, and the usage requests for the other request-accepting apparatuses are cancelled, so it is possible to conduct usage request management without determining the request-accepting device to be used when the instruction for use is made. Consequently, it becomes possible to select the request-accepting apparatus that has become available first, according to changes in the usage request status of each of the request-accepting apparatuses at that point in time, and to use the same, while maintaining the position of the usage request established when the instruction for use was made, thereby achieving flexible usage request management.

It is preferable that the usage request method according to the first aspect of the invention further includes each of the request-accepting apparatuses that have accepted the usage request from the requesting-making apparatus adding the usage request from the request-making apparatus as the lowest priority request to a usage request list, updating the usage request list; each of the request-accepting apparatuses notifying the request-making apparatus matching the top priority usage request on the usage request list of information indicating that that request-accepting apparatus is currently available; each of the request-accepting apparatus notified of cancellation of the usage request deleting the usage request from the usage request list, updating the usage request list; and upon each of the request-accepting apparatuses executing a job relevant to the top priority usage request on the usage request list, deleting the top priority usage request from the usage request list, updating the usage request list.

It is preferable that the notifying two or more of the request-accepting apparatuses of a usage request includes: upon the request-making apparatus receiving the instruction to use one of the request-accepting apparatuses, outputting to a user information about one or more request-accepting apparatuses, from among the request-accepting apparatus, that can be notified by the request-making apparatus of the usage request; the request-making apparatus selecting a plurality of request-accepting apparatuses from among the request-accepting apparatuses that can be notified of the usage request, in accordance with a user's instruction; and the request-making apparatus notifying the selected request-accepting apparatuses of the usage request.

It is preferable that the notifying of cancellation of the usage request includes: upon the request-making apparatus receiving, from one of the request-accepting apparatuses notified of the usage request, information indicating that the request-accepting apparatus is currently available, asking a user whether or not to use the request-accepting apparatus; if the request-making apparatus receives a response from the user to use the request-accepting apparatus, setting the request-accepting apparatus as an object to be used, and notifying the one or more request-accepting apparatuses notified of the usage request other than the one set as the object to be used of cancellation of the usage request; and if the request-making apparatus receives a response from the user not to use the request-accepting apparatus, notifying the request-accepting apparatus of cancellation of the usage request.

The above configuration makes it possible to select a request-accepting apparatus to be notified of a usage request and determine the request-accepting apparatus to be used upon confirming a user's intention.

The usage request management method according to a second aspect of the invention is a usage request management method for a network system including a plurality of request-making apparatuses that make one or more usage requests, and a plurality of request-accepting apparatuses that accept one or more usage requests, including: upon a request-accepting apparatus from among the request-accepting apparatuses accepting a usage request from a request-making apparatus from among the request-making apparatus, adding the usage request from the request-making apparatus as the lowest priority usage request to a usage request list, updating the usage request list; upon a request-accepting from among the request-accepting apparatuses being available, notifying the request-making apparatus matching the top priority usage request on the usage request list of information indicating that that request-accepting apparatus is currently available; when the request-making apparatus matching the top priority usage request has notified the one or more other request-accepting apparatuses of the usage request relating to a job relevant to the top priority usage request, notifying the one or more other request-accepting apparatuses of cancellation of the usage request relating to the job from the request-making apparatus matching the top priority usage request; upon each of the one or more other request-accepting apparatuses being notified of the cancellation of the usage request, deleting the usage request from its usage request list, updating the usage request list; and upon the request-accepting apparatus executing the job relevant to the top priority usage request on the usage request list, deleting the top priority usage request from the usage request list, updating the usage request list.

The method according to the above aspects of the invention can be performed with a computer in a request-requesting apparatus and/or a request-accepting apparatus. The computer program to execute the method can be installed or loaded in the computer via various media such as a CD-ROM, a magnetic disk, semiconductor memory or a communication network.

The apparatus according to a third aspect of the invention is a request-making apparatus that makes a usage request for a request-accepting apparatus that accepts a usage request via a network, the request-making apparatus including: a function that, upon receipt of an instruction to use a request-accepting apparatus, notifies a plurality of request-accepting apparatuses of a usage request; and a function that, upon receiving, from one of the request-accepting apparatuses notified of the usage request, information indicating that the request-accepting apparatus is currently available, sets the request-accepting apparatus as an object to be used, and notifies the one or more request-accepting apparatuses notified of the usage request other than the one set as the object to be used of cancellation of the usage request.

The apparatus according to a fourth aspect of the invention is a request-accepting apparatus that accepts a usage request from a request-making apparatus that makes a usage request via a network, the request-accepting apparatus including: a function that, upon receipt of a usage request from the request-making apparatus, adds the usage request from the request-making apparatus as the lowest priority request to a usage request list, updating the usage request list; a function that, upon the request-accepting apparatus being available, notifies the request-making apparatus matching the top priority usage request on the usage request list of information indicating that the request-accepting apparatus is currently available; a function that, when the request-making apparatus matching the top priority usage request has notified one or more other request-accepting apparatuses of the usage request relating to a job relevant to the top priority usage request, notifies the one or more other request-accepting apparatuses of cancellation of the usage request relating to the job from the request-making apparatus matching the top priority usage request; a function that, upon receipt of cancellation of a usage request, deletes the usage request from the usage request list, updating the usage request list; and a function that, upon execution of the job relevant to the top priority usage request on the usage request list, deletes the top priority usage request from the usage request list, updating the usage request list.

### BRIEF DESCRIPTION OF THE DRAWINGS

FIG. 1 is a block diagram showing the configuration of a network system 1 according to an embodiment of the invention.

FIGS. 2A and 2B are block diagrams showing the function configurations of a scanner driver 15, and a scanner controller 25.

FIG. 3 is a flowchart showing processing performed by usage request accepting/cancelling means 28.

FIG. 4 is a flowchart showing processing performed by execution order management means 29.

FIG. 5 is a flowchart showing processing performed by adaptive usage request means 18.

FIG. 6 is a flowchart showing processing performed by adaptive usage request means 18.

FIGS. 7A and 7B are diagrams explaining usage request lists.

### DESCRIPTION OF EXEMPLARY EMBODIMENTS

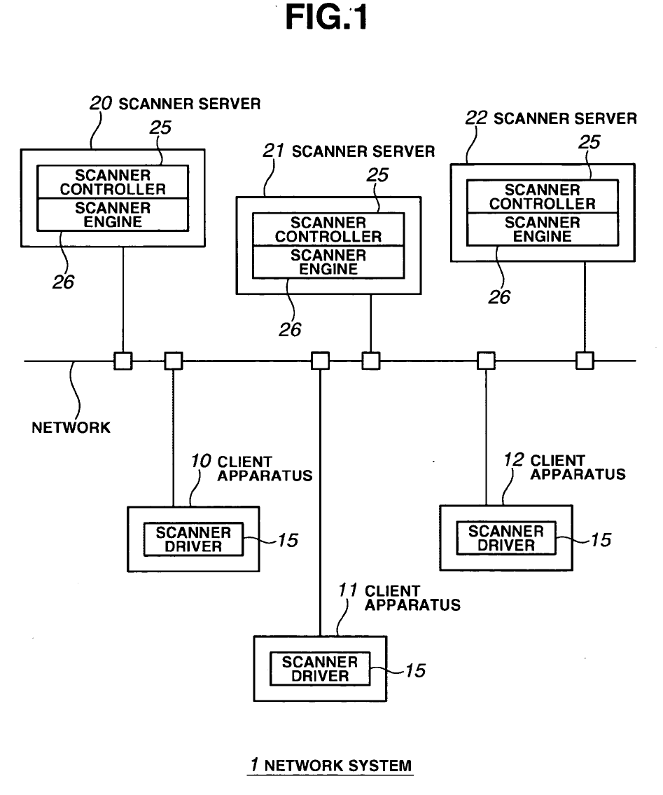

FIG. 1 is a block diagram showing the configuration of a network system 1 according to an embodiment of the invention. As shown in FIG. 1, the network system 1 includes client apparatuses 10, 11, and 12, each corresponding to an apparatus that makes usage requests, and scanner servers 20, 21, and 22, each corresponding to an apparatus that accepts usage requests. These apparatuses are configured so that they can communicate with each other via a predetermined communication network (which may be a LAN, the Internet, a dedicated line, a packet communication network, or a combination of any of these, and includes both wired and wireless networks).

In this embodiment, the network system 1 has three client apparatuses, and three scanner servers, but the number of these apparatuses and servers only has to be plural, and can be determined according to the design.

The client apparatuses 10, 11, and 12 may be configured with, for example, generally-used personal computers, and each include hardware such as a CPU, ROM, RAM, a user interface, and a network interface.

Each of the client apparatuses 10, 11, and 12 also includes a scanner driver 15, having, for example, a color tone correction means, a histogram correction means, and a density correction means as ordinary control functions necessary for making the scanner servers 20, 21, and 22 execute scanning processing.

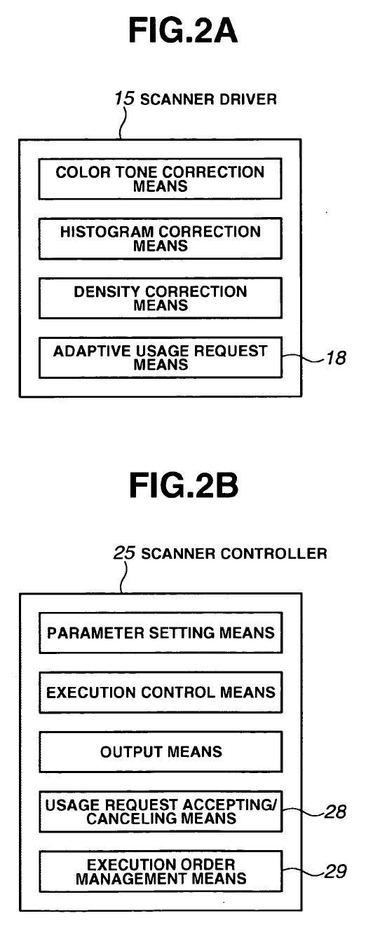

The scanner driver 15 according to this embodiment includes, in addition to the aforementioned functional means that ordinary scanner drivers have, an adaptive usage request means 18 that enables determination of which scanner server to use in a manner adaptive to changes in the usage request status (i.e., the function that, upon receipt of an instruction to use a scanner server, notifies a plurality of scanner servers of a usage request; and the function that, upon receiving, from one of the scanner servers notified of the usage request, information indicating that the scanner server is currently available, determines, as the object to be used, the scanner server that information was received from, and notifies the scanner servers that have been notified of the usage request other than that determined as the object to be used of usage request cancellation. (See FIG. 2.)

Each means in the scanner driver 15 activates by the CPU executing a program stored in the ROM, or the RAM in the relevant apparatus, or any external memory medium or the like.

Each of the scanner servers 20, 21, and 22 includes a scanner controller 25, and a scanner engine 26.

The scanner controller 25 includes hardware such as a CPU, ROM, RAM, a user interface, and a network interface. However, the network interface may be provided separately from the scanner servers 20, 21, and 22.

The function configuration of the scanner controller 25 is the same as that of a scanner controller in an ordinary scanner. For example, the scanner controller 25 includes a parameter setting means that configures various read operation settings based on the scan mode, an execution control means that controls the scanner engine 26 based on instructions from a user or the client apparatuses 10, 11, or 12 to execute read operation, and an output means that outputs image data to the exterior (e.g., outputs it to the client apparatuses 10, 11, or 12 via the network interface).

The scanner controller 25 according to this embodiment further includes request accepting/cancelling means 28 (the function that, upon receipt of a usage request from a client apparatus, adds the usage request from that client apparatus as the lowest priority usage request to a usage request list, updating the usage request list; and the function that, upon receipt of a cancellation of a usage request, deletes the request from the usage request list, updating the usage request list), and an execution order management means 29 (the function that notifies the client apparatus matching the top priority usage request on the usage request list of information indicating that the request-accepting apparatus is currently available; and the function that, upon executing processing corresponding to the top priority request on the usage request list, deletes the top priority usage request from the usage request list, updating the usage request list (See FIG. 2).

Each means in the scanner controller 25 activates by the CPU executing a program stored in the ROM or RAM in the relevant apparatus, or any external memory medium or the like.

The scanner engine 26 includes, for example, an input scan head, a scan mechanism, a light source, and controlled by the scanner controller 25, optically reads contrast density on an original medium to form image data. For the scanner engine 26, various kinds of scanner engines such as a drum scanner, a flat head scanner, or a CCD scanner can be used.

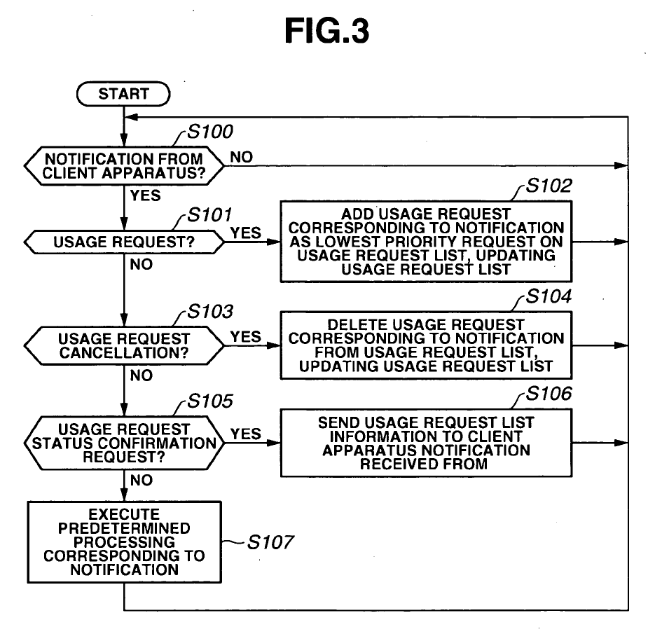

Here, the request accepting/cancelling means 28, the execution order management means 29, and the adaptive usage request means 18 will be explained below with reference to the flowcharts shown in FIGS. 3 to 6. The order of the steps (including any partial step not provided with a reference numeral) may arbitrarily be changed and the steps may also be executed in parallel, so long as the change causes no anomaly in the processing content.

RequestAccepting/Canceling Means: FIG. 3

The request accepting/cancelling means 28 waits until it receives a notification concerning a usage request from a client apparatus (S100).

The usage request accepting/cancelling means 28, upon receipt of a notification concerning a usage request from a client apparatus, judges whether that notification is a usage request (S101).

If it is a usage request, the request accepting/cancelling means 28 adds the usage request corresponding to that notification as the lowest priority usage request to a usage request list, updating the usage request list (S102), and then returns to S100.

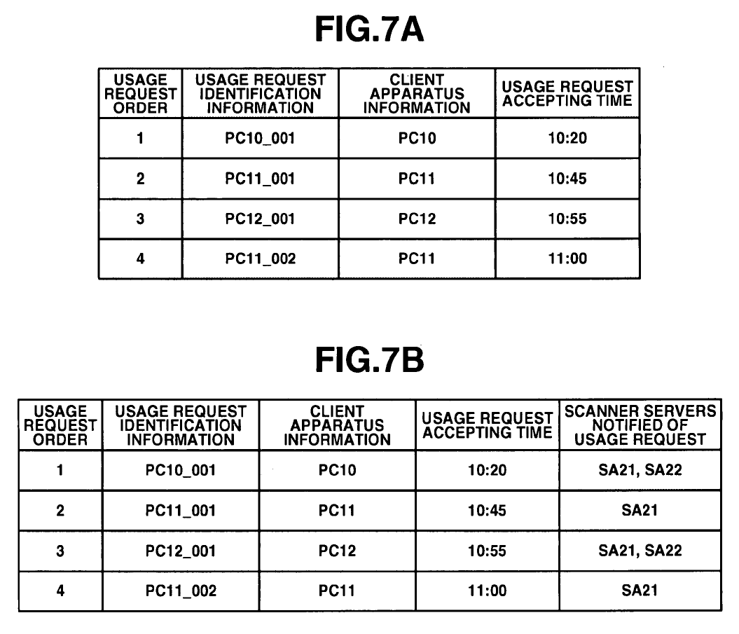

The usage request list, which can include the order of usage request, usage request identification information (e.g., usage request name), information on the client apparatus a usage request was received from (e.g., apparatus name), and the time when a usage request has been accepted as shown in FIG. 7A, is stored in a predetermined area of the RAM. It is preferable that the request accepting/cancelling means 28 notifies the client apparatus a usage request was received from of the usage request identification information so that that client apparatus can cancel the usage request based on that information.

Meanwhile, If it is not a usage request, the usage request accepting/cancelling means 28 judges whether it is a notification for usage request cancellation (S103).

If it is a notification for usage request cancellation and the usage request corresponding to that notification is registered in the usage request list, the usage request accepting/cancelling means 28 deletes the usage request corresponding to the notification from the usage request list, updating the usage request list (S104), and then returns to S100.

Meanwhile, if it is not a notification for usage request cancellation, the usage request accepting/cancelling means 28 judges whether the notification is a usage request status confirmation request (S105).

If it is a usage request status confirmation request, the usage request accepting/cancelling means 28 sends usage request list information to the client apparatus the notification was received from (S106), and then returns to S100.

If it is not a usage request status confirmation request, the usage request accepting/cancelling means 28 executes predetermined processing corresponding to that notification (S107), and then returns to S100.

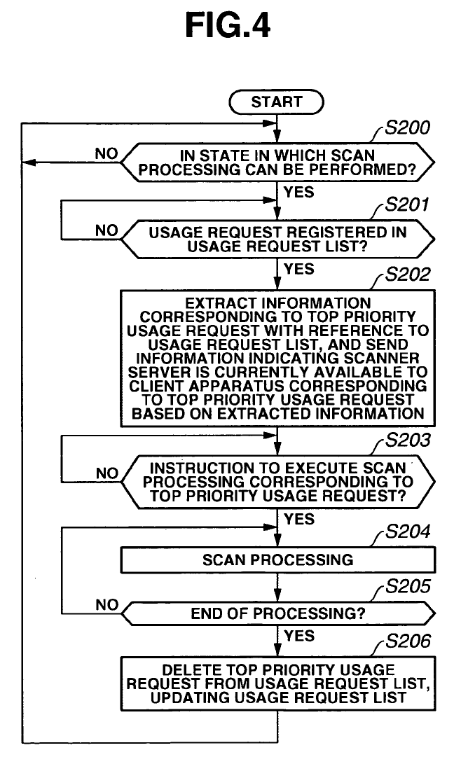

Execution Order Management Means: FIG. 4

Based on the status of the corresponding scanner engine 26, the execution order management means 29 judges whether the relevant scanner server is in a state in which scan processing can be executed (S200).

If it is not in that state, the execution order management means 29 returns to S200. Meanwhile, if it is, the execution order management means 29 judges whether usage requests are registered, with reference to the usage request list (S201).

If no usage requests are registered, the execution order management means 29 returns to S201 and waits until a usage request is registered.

Meanwhile, if usage requests are registered in the usage request list, information corresponding to the top priority usage request (such as usage request identification information, client apparatus name, etc.) is extracted with reference to the usage request list, and based on that extracted information, information indicating that the request-accepting apparatus is currently available is sent to the client apparatus matching the top priority usage request (S202).

Next, the execution order management means 29 waits for an instruction to execute the scan processing (job) corresponding the top priority usage request (S203), and upon receipt of that execution instruction from the user or the client apparatus, instructs the execution control means to execute the corresponding scan processing (S204).

Next, the execution order management means 29 waits until the corresponding scan processing ends (S205), and upon the end of the processing, deletes the top priority usage request from the usage request list, updating the usage request list (S206), and then returns to S200.

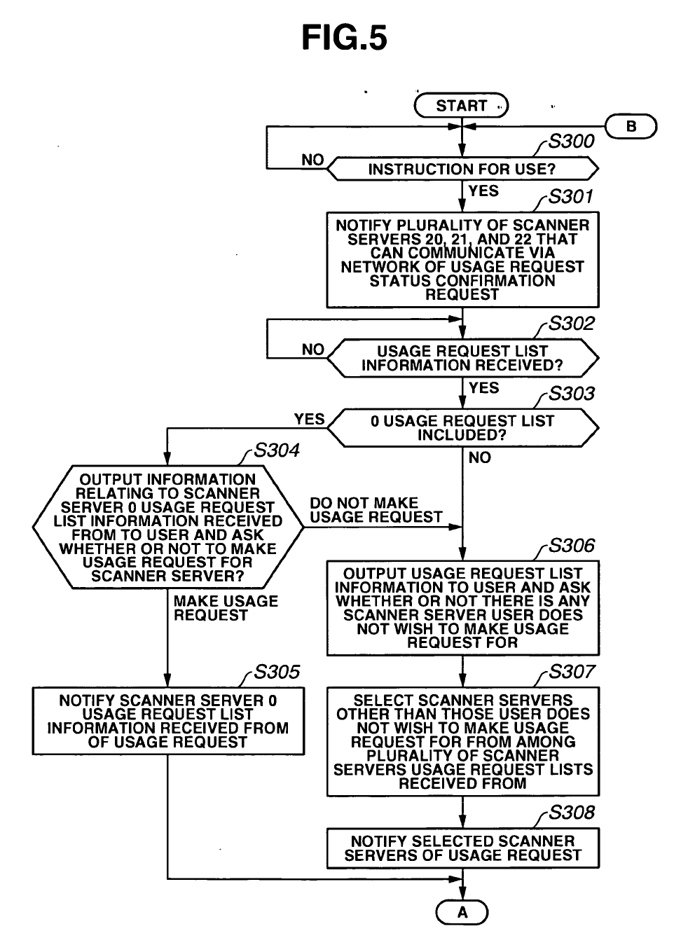

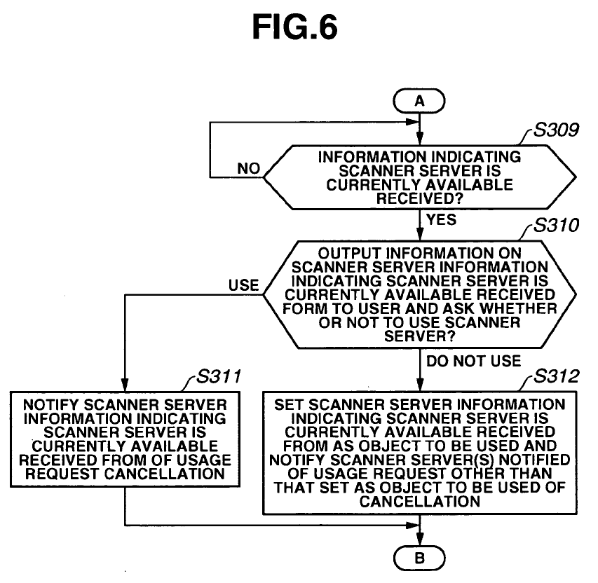

Adaptive Usage request Means: FIG. 5 and FIG. 6

The adaptive usage request means 18 waits until it receives an instruction to use a scanner server from a user or an application that operates on a client apparatus (S300).

The adaptive usage request means 18, upon receipt of an instruction to use a scanner server, notifies the plurality of scanner servers 20, 21, and 22, which can communicate via a network, of a usage request status confirmation request (S301).

Next, the adaptive usage request means 18 waits until it receives usage request list information from the scanner servers 20, 21, and 22 notified of the usage request status confirmation request (S302).

When usage request list information is sent from any of the scanner servers in response to the usage request status confirmation request, the client apparatus and the relevant scanner server can be considered as being in the state in which they can communicate with each other (e.g., in the state in which a usage request can be sent from the client apparatus to the scanner server). Hereinafter, the processing flow for the case where the adaptive usage request means 18 receives usage request list information from two or more scanner servers within a predetermined period of time (i.e., where a usage request can be sent to two or more scanner servers) is explained below. If it has received no usage request list information within a predetermined period of time, it notifies the user that there are no scanners for which a usage request can be made. If it has received usage request list information from only one scanner server within a predetermined period of time, ordinary usage request processing may be executed on that scanner server.

Next, the adaptive usage request means 18 judges whether the received usage request list information includes any usage request list information with no usage requests registered (0 usage request list) (S303).

If it includes 0 usage request list information, the adaptive usage request means 18 selects the scanner server the 0 usage request list information was received from, outputs information relating to the selected scanner server (the name and installed position, etc., of the scanner server) to the user, and asks the user whether to make a usage request for the selected scanner server or not (S304).

If there is an input from the user to make a usage request for the selected scanner server (S304: “MAKE USAGE REQUEST”), the adaptive usage request means 18 notifies the selected scanner server of a usage request corresponding to the instruction for use (S305), and then proceeds to S309.

Meanwhile, if the received usage request list information includes no 0 usage request list information (S303: NO), or if there is an input from the user not to make a usage request for the selected scanner server (S305: “DO NOT MAKE USAGE REQUEST”), the adaptive usage request means 18 outputs the received usage request list information to the user, and asks the user whether there is any scanner server the user does not wish to make a usage request for (S306). In response to this, the user may designate scanner server(s) the user does not wish to make a usage request for by, for example, eliminating scanner servers with many usage requests, or scanner servers located away from the user's own seat, based on the usage request list information.

Next, the adaptive usage request means 18, upon the user's response being input, selects a scanner server other than the scanner server(s) the user does not wish to make a usage request for, from among the plurality of scanner servers the usage request list information was received from (S307).

Here, the processing flow for when there is a plurality of scanner servers selected at the above step will be explained below. When only one scanner server is selected as a result of selection according to the user's instructions, ordinary usage request processing may be performed on that scanner server.

The adaptive usage request means 18 notifies the plurality of selected scanner servers of a usage request corresponding to the instruction for use (S308).

Next, the adaptive usage request means 18 waits until it receives, from any of the scanner servers notified of the usage request corresponding to the instruction for use, information indicating that the scanner server is currently available (S309).

The adaptive usage request means 18, upon receiving, from any of the scanner servers notified of the usage request, information indicating that the scanner server is currently available, outputs information about the scanner server the information was received from (the name, installed position, etc., of the scanner server) to the user, and asks the user whether to use that scanner server or not (S310).

The adaptive usage request means 18, if receiving a response from the user not to use the scanner server (S310: “DO NOT USE”), notifies the scanner server the information was received from of a usage request cancellation (S311), and then returns to S309. Although not shown in the Figure, if there are inputs not to use any of the scanner servers notified of the usage request as a result of the user sequentially making an input not to use each one of them, the adaptive usage request means 18 returns to S300.

Meanwhile, the adaptive usage request means 18, if receiving a response from the user to use the scanner server the above information was received from (S310: “USE”), sets the scanner server the information was received from as the object to be used, and sends cancellation of the usage request corresponding to the instruction for use to the scanner server(s) notified of that request other than the one set as the object to be used (and the ones where the usage requests have been cancelled)(S312), and then returns to S300.

According to the configuration according to this embodiment, when an instruction for use is received, the corresponding usage request is sent to a plurality of scanner servers, while when one of the scanner servers that have accepted the usage request corresponding to the instruction for use becomes available as a result of * progression of dealing with the usage requests in each of the scanner servers, that scanner server is set as the object to be used and the usage requests for the other scanner servers are cancelled based on the user's instructions. Thus, it is possible to conduct usage request management without setting the scanner server to be used at the time an instruction for use is made. Consequently, it is possible to select a scanner server that first becomes available according to changes in the usage request status of each of the scanner servers and to use it, while maintaining the position of the usage request established when the instruction for use was made, thereby achieving flexible usage request management.

The above configuration does not require setting the scanner server to be used when an instruction for use is made, i.e., it does not require selecting one specific scanner server when an instruction for use is made. Accordingly, the usage request information for each of the scanner servers that has conventionally been required will not necessarily be required. Consequently, it will not be necessary to have a usage request management server for providing usage request information, which will reduce costs, etc.

As described above, the invention makes it possible to, when a plurality of users (clients) share a plurality of networked devices, conduct flexible usage request management, such as determining the device to be used according to changes in the usage request status of each of the devices without a usage request management server being separately provided.

Others

The invention is not limited to the above embodiment, and various modifications thereof can be adopted.

For example, in the above embodiment, the adaptive usage request means is described as a functional means in the scanner driver 15, but it may be an independent functional means separate from the scanner driver 15. In that case, even with a client apparatus with no scanner driver installed (e.g., a portable terminal), it is possible to make a usage request based on the scheme according to the invention by having the adaptive usage request means in that client apparatus.

Also, the above embodiment is configured so that a usage request cancellation is sent from a client apparatus. However, the present invention may be configured so that a usage request cancellation is sent from a scanner server to another scanner server. For example, the present invention may be configured so that, when a usage request is sent from a client apparatus to a scanner server, it can be sent together with information about the other scanner servers the usage request has been sent to, and the scanner server forms a usage request list with the information about the other scanner servers added as shown in FIG. 7B. Also, the invention may be configured so that the execution order management means 29 sends information indicating that the relevant scanner server is currently available to the client apparatus matching the top priority usage request, while sending a usage request cancellation relating to the job relevant to the usage request to the other scanner servers notified by the client apparatus matching the top priority usage request of the usage request relating to the job relevant to the usage request.

The present invention may also be configured so that at any time during waiting for information indicating that any scanner server is currently available after the notification of a usage request, a usage request status confirmation request can be sent to scanner servers to obtain usage request list information, and that information can be output to the user to enable the user to see changes in the usage request status of each of the scanner servers. It may further be configured so that a scanner server, when updating a usage request list, actively sends usage request list information to a client apparatus.

The above embodiment describes the case where a client apparatus is an apparatus that makes a usage request (requesting-making apparatus) and a scanner server is an apparatus that accepts a usage request (request-accepting apparatus). However, the invention is not limited to such a configuration. Any network system that includes a plurality of request-making apparatuses and request-accepting apparatuses can achieve flexible usage request management by adopting the scheme according to the invention.

What is claimed is:

1. A method of making a usage request for one or more of a plurality of request-accepting apparatuses that accept one or more usage requests in a network system including a plurality of request-making apparatuses that make one or more usage requests, and the request-accepting apparatuses, comprising:
upon a request-making apparatus from among the request-making apparatuses receiving an instruction to use one of the request-accepting apparatuses, notifying two or more of the request-accepting apparatuses of a usage request; and
upon the request-making apparatus receiving, from a request-accepting apparatus from among the request-accepting apparatuses notified of the usage request, information indicating that the request-accepting apparatus is currently available, setting the request-accepting apparatus the information was received from as an object to be used, and notifying the one or more request-accepting apparatuses notified of the usage request other than the one set as the object to be used of cancellation of the usage request.

2. The method according to claim 1 further comprising:
each of the request-accepting apparatuses that have accepted the usage request from the requesting-making apparatus adding the usage request from the request-making apparatus as the lowest priority request to a usage request list, updating the usage request list;
each of the request-accepting apparatuses notifying the request-making apparatus matching the top priority usage request on the usage request list of information indicating that the request-accepting apparatus is currently available;
each of the request-accepting apparatus notified of cancellation of the usage request deleting the usage request from the usage request list, updating the usage request list; and
upon each of the request-accepting apparatuses executing a job relevant to the top priority usage request on the usage request list, deleting the top priority usage request from the usage request list, updating the usage request list.

3. The method according to claim 1,
wherein the notifying two or more of the request-accepting apparatuses of a usage request includes:
upon the request-making apparatus receiving the instruction to use one of the request-accepting apparatuses, outputting to a user information about one or more request-accepting apparatuses, from among the request-accepting apparatus, that can be notified by the request-making apparatus of the usage request;
the request-making apparatus selecting a plurality of request-accepting apparatuses from among the request-accepting apparatuses that can be notified of the usage request, in accordance with a user's instruction; and
the request-making apparatus notifying the selected request-accepting apparatuses of the usage request.

4. The method according to claim 1,
wherein the notifying of cancellation of the usage request includes:
upon the request-making apparatus receiving, from one of the request-accepting apparatuses notified of the usage request, information indicating that the request-accepting apparatus is currently available, asking a user whether or not to use the request-accepting apparatus;
if the request-making apparatus receives a response from the user to use the request-accepting apparatus, setting the request-accepting apparatus as an object to be used, and notifying the one or more request-accepting apparatuses notified of the usage request other than the one set as the object to be used of cancellation of the usage request; and
if the request-making apparatus receives a response from the user not to use the request-accepting apparatus, notifying the request-accepting apparatus of cancellation of the usage request.

5. The method according to claim 1, wherein the request-accepting apparatuses are network-connectable scanner apparatuses.

6. A usage request management method for a network system including a plurality of request-making apparatuses that make one or more usage requests, and a plurality of request-accepting apparatuses that accept one or more usage requests, comprising:
upon a request-accepting apparatus from among the request-accepting apparatuses accepting a usage request from a request-making apparatus from among the request-making apparatus, adding the usage request from the request-making apparatus as the lowest priority usage request to a usage request list, updating the usage request list;
upon a request-accepting apparatus from among the request-accepting apparatuses being available, notifying the request-making apparatus matching the top priority usage request on the usage request list of information indicating that the request-accepting apparatus is currently available;
when the request-making apparatus matching the top priority usage request has notified the one or more other request-accepting apparatuses of the usage request relating to a job relevant to the top priority usage request, notifying the one or more other request-accepting apparatuses of cancellation of the usage request relating to the job from the request-making apparatus matching the top priority usage request;
upon each of the one or more other request-accepting apparatuses being notified of the cancellation of the usage request, deleting the usage request from its usage request list, updating the usage request list; and
upon the request-accepting apparatus executing the job relevant to the top priority usage request on the usage request list, deleting the top priority usage request from the usage request list, updating the usage request list.

7. A request-making apparatus that makes a usage request for a request-accepting apparatus that accepts a usage request via a network, the request-making apparatus comprising:
a function that, upon receipt of an instruction to use a request-accepting apparatus, notifies a plurality of request-accepting apparatuses of a usage request; and
a function that, upon receiving, from one of the request-accepting apparatuses notified of the usage request, of information indicating that the request-accepting apparatus is currently available, sets the request-accepting apparatus as an object to be used, and notifies the one or more request-accepting apparatuses notified of the usage request other than the one set as the object to be used of cancellation of the usage request.

8. A request-accepting apparatus that accepts a usage request from a request-making apparatus that makes a usage request via a network, the request-accepting apparatus comprising:
a function that, upon receipt of a usage request from the request-making apparatus, adds the usage request from the request-making apparatus as the lowest priority request to a usage request list, updating the usage request list;
a function that, upon the request-accepting apparatus being available, notifies the request-making apparatus matching the top priority usage request on the usage request list of information indicating that the request-accepting apparatus is currently available;
a function that, when the request-making apparatus matching the top priority usage request has notified one or more other request-accepting apparatuses of the usage request relating to a job relevant to the top priority usage request, notifies the one or more other request-accepting apparatuses of cancellation of the usage request relating to the job from the request-making apparatus matching the top priority usage request;
a function that, upon receipt of cancellation of a usage request, deletes the usage request from the usage request list, updating the usage request list; and
a function that, upon execution of the job relevant to the top priority usage request on the usage request list, deletes the top priority usage request from the usage request list, updating the usage request list.

9. A program for executing the method according to claim 1 with a computer.
